(19) United States
(12) Patent Application Publication
(10) Pub. No.: US 2026/0010159 A1
(43) Pub. Date: Jan. 8, 2026

(54) INTEGRATED VEHICLE TELEOPERATION CONTROL UNITS TO FACILITATE REMOTE OPERATION AND ASSOCIATED METHODS

(71) Applicant: Vay Technology GmbH, Berlin (DE)

(72) Inventors: Guilherme Müller, Berlin (DE); Athanassios Lagospiris, Kornwestheim (DE); Bogdan Djukic, Berlin (DE); Christoph Menzel, Berlin (DE); Bartek Szurgot, Wroclaw (PL); Richard Schubert, Guadalupe (CR); Jesus-Gonzalez Tejeria, Eindhoven (NL)

(73) Assignee: Vay Technology GmbH, Berlin (DE)

(21) Appl. No.: 18/765,733

(22) Filed: Jul. 8, 2024

(30) Foreign Application Priority Data
Jul. 4, 2024 (GR) 20240100480

(51) Int. Cl. G05D 1/224; B25J 9/16; H04L 67/12

(52) U.S. Cl. CPC G05D 1/2247; B25J 9/1689; H04L 67/12

(57) ABSTRACT

A vehicle teleoperation system may comprise a single, integrated unit that is installed within a vehicle to enable remote driving operations. The vehicle teleoperation system may include a processing island, a connectivity island, a safety island, and various interfaces by which to connect the vehicle teleoperation system to various systems onboard a vehicle. For example, the vehicle teleoperation system may receive and process various sensor data, transmit the sensor data for presentation to a teleoperator at a teleoperator station, receive and process user commands from the teleoperator at the teleoperator station, and instruct remote execution of the user commands by the vehicle.

### CROSS-REFERENCE TO RELATED APPLICATION

This application claims priority to Greek patent application No. 20240100480, filed by Applicant on Jul. 4, 2024, the contents of which are herein incorporated by reference in their entirety.

### BACKGROUND

Teleoperated remote driving of a vehicle is considered to be an enabling technology toward fully autonomous driving. In such remote driving applications, a teleoperator may use a teleoperator station to view a live video stream representing the vehicle's environment, and to remotely drive the vehicle via a wireless communication network. In order to facilitate safe and reliable communication between the teleoperator station and a remotely driven vehicle, various devices, controllers, or other systems may need to be installed in and/or interface with various vehicle systems to enable teleoperation. Accordingly, there is a need for simple, integrated, and portable vehicle teleoperation control units, systems, and methods to enable safe and reliable remote operation of such vehicles.

### BRIEF DESCRIPTION OF THE DRAWINGS

FIG. 1 is a schematic diagram of a remote driving system including an example vehicle teleoperation system, in accordance with implementations of the present disclosure.

FIG. 2 is a schematic diagram of a vehicle including an example vehicle teleoperation system, in accordance with implementations of the present disclosure.

FIG. 3 is a schematic diagram of a first example embodiment of a vehicle teleoperation system, in accordance with implementations of the present disclosure.

FIG. 4 is a schematic diagram of a first example platform for an example vehicle teleoperation system, in accordance with implementations of the present disclosure.

FIG. 5 is a schematic diagram of a second example platform for an example vehicle teleoperation system, in accordance with implementations of the present disclosure.

FIG. 6 is a schematic diagram of a second example embodiment of a vehicle teleoperation system, in accordance with implementations of the present disclosure.

FIG. 7 is a schematic diagram of a third example embodiment of a vehicle teleoperation system, in accordance with implementations of the present disclosure.

FIG. 8 is a schematic diagram of a fourth example embodiment of a vehicle teleoperation system, in accordance with implementations of the present disclosure.

FIG. 9 is a schematic diagram of a fifth example embodiment of a vehicle teleoperation system, in accordance with implementations of the present disclosure.

FIG. 10 is a flow diagram illustrating an example vehicle teleoperation system installation process, in accordance with implementations of the present disclosure.

FIG. 11 is a flow diagram illustrating an example vehicle teleoperation system operation process, in accordance with implementations of the present disclosure.

### DETAILED DESCRIPTION

As is set forth in greater detail below, implementations of the present disclosure are directed to simple, integrated, and portable vehicle teleoperation control units, systems, and methods to enable safe and reliable remote operation of vehicles via wireless communication networks.

In example embodiments, a vehicle may comprise one or more cameras or other sensors to capture data associated with an environment proximate the vehicle. In addition, the vehicle may comprise a vehicle motion controller that communicates with various vehicle systems to instruct operation of the vehicle, e.g., throttle, braking, steering, and various peripherals. Further, a teleoperator or teledriving station, e.g., telecenter, may be in communication with the vehicle via a wireless communication network, and the teleoperator station may receive video, audio, and/or other sensor data that is presented or provided to a teleoperator. Based on the received data, the teleoperator station may receive inputs or commands from the teleoperator, which inputs or commands may then be communicated to the vehicle via the wireless communication network in order to remotely operate or drive the vehicle.

In example embodiments, the vehicle may be equipped with an example vehicle teleoperation system that facilitates safe and reliable communication between the teleoperator station and the remotely driven vehicle. The vehicle teleoperation system may comprise a single, integrated unit that may be positioned or installed within the vehicle, and connected to various vehicle systems via appropriate interfaces. For example, the vehicle teleoperation system may comprise one or more video, audio, and/or other sensor interfaces, a processing island for video and/or connectivity data, a connectivity island, a safety island, and/or one or more external interfaces to a vehicle motion controller, storage, and/or peripherals associated with the vehicle.

Various generic platforms or configurations of vehicle teleoperation systems described herein may be utilized based on types, configurations, or existing equipment of vehicles. In some examples, for vehicles that may include existing equipment such as cameras, video processing units, and vehicle motion controller, a first platform, e.g., a large-scale generic platform, of an example vehicle teleoperation system may include a processing island for connectivity data, a connectivity island, and a safety island, and the first platform may communicate with the vehicle's existing cameras, video processing units, and vehicle motion controller.

In other examples, for vehicles that do not include any existing equipment such as cameras, video processing units, and vehicle motion controller, a second platform, e.g., a small/mid-scale generic platform, of an example vehicle teleoperation system may include one or more cameras, microphones, speakers, or other sensors, one or more sensor interfaces, one or more processing islands for video data and connectivity data, a connectivity island, a safety island, a vehicle motion controller, and one or more external interfaces to storage and/or peripherals associated with the vehicle, and the second platform may communicate with various vehicle systems to remotely operate the vehicle, e.g., using the integrated vehicle motion controller. Various other types of generic platforms or configurations may have different combinations of the various portions, islands, interfaces, or subsystems of a vehicle teleoperation system described herein, e.g., generally based on types, configurations, or existing equipment of vehicles.

In additional example embodiments, an example vehicle teleoperation system may be split or divided into two or more processors, chips, or cores, with the two or more processors, chips, or cores still being combined or formed into a single, integrated unit. In this manner, various functions or operations of the processing island for video data, the processing island for connectivity data, the connectivity island, and/or the safety island may be logically, electrically, and/or physically separated onto multiple processors, chips, or cores, while the multiple processors, chips, or cores are still combined or formed into a single, integrated unit. In some examples, the separation of various functions or operations of the example vehicle teleoperation system onto multiple processors, chips, or cores may facilitate or enable modular and/or distributed design, such that different and/or multiple modules may be combined to form an integrated unit as desired or needed, e.g., based types, configurations, or existing equipment of vehicles.

Using the example vehicle teleoperation systems and methods described herein, safe and reliable remote operation of vehicles may be enabled for various types or configurations of vehicles. In addition, the example vehicle teleoperation systems may comprise single, integrated units that may be more easily, quickly, and efficiently installed in vehicles and connected to various vehicle systems, without requiring the significant time, cost, or effort to disassemble, modify, and re-assemble portions of vehicles for remote operation using conventional controllers that may individually perform subsets of the teleoperation functions or operations described herein.

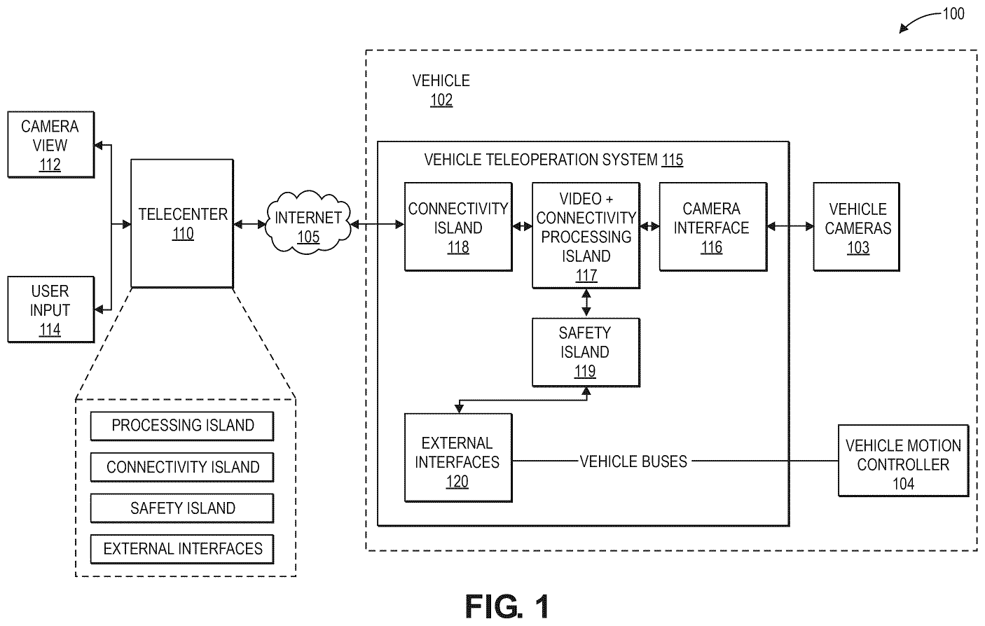

FIG. 1 is a schematic diagram 100 of a remote driving system including an example vehicle teleoperation system, in accordance with implementations of the present disclosure.

As shown in FIG. 1, the example remote driving system may comprise a vehicle 102 that is adapted to be remotely driven, controlled, or instructed by a teleoperator via a wireless communication network 105, e.g., the Internet. In addition, the example remote driving system may comprise a teleoperator station or telecenter 110 for use by a teleoperator to remotely drive, control, or instruct the vehicle 102 via the wireless communication network 105.

In example embodiments, the vehicle 102 may comprise a car, such as a small car, a regular car, a Sports Utility Vehicle (SUV), a van, a truck, or any other type of commercial, industrial, or personal vehicle that is adapted to be remotely driven, controlled, or instructed. The vehicle 102 may comprise or include various on-board infrastructure to enable or facilitate teleoperation, e.g., cameras 103, other sensors, sensor processing units, and/or vehicle motion controller 104. For example, the vehicle 102 may include one or more imaging devices, cameras, or other sensors 103 for capturing imaging data of the vehicle's environment, and/or one or more audio sensors or arrays, radar sensors, LIDAR (light detection and ranging) sensors, or other types of sensors for detecting or capturing data associated with the vehicle's environment. In addition, the vehicle motion controller 104 may interface or connect with various vehicle systems, e.g., throttle, braking, steering, and/or various peripherals or accessories, to remotely operate the vehicle 102.

The imaging devices or cameras 103 associated with the vehicle 102 may comprise various types of imaging sensors, analog cameras, digital cameras, video cameras, depth sensors, infrared sensors, time-of-flight sensors, or other types of imaging sensors. The imaging devices or cameras 103 may be positioned and oriented at various positions on the vehicle 102 in order to capture imaging data of an environment at least partially around the vehicle 102, e.g., towards a forward movement direction, towards a rearward movement direction, and/or toward various other portions of a periphery of the vehicle 102. In addition, the imaging devices or cameras 103 may capture imaging data, such as video data, live video streams, or other types of imaging data, which may be processed and transmitted to the teleoperator station 110 and used to facilitate remote operation of the vehicle 102, as further described herein.

The audio sensors or arrays associated with the vehicle 102 may comprise various types of microphones, microphone arrays, audio transducers, piezoelectric elements, and/or other types of audio sensors. The audio sensors or arrays may be positioned and oriented at various positions on the vehicle 102 in order to detect and capture audio data of an environment at least partially around the vehicle 102. In some examples, an audio sensor array or microphone array may be beamformed to detect and capture audio data at particular desired positions or locations relative to the vehicle 102. In addition, the audio sensors or arrays may capture audio data, such as voices, speech, footsteps, bicycles, tire or road noise, vehicles, engines, motors, or other types of sounds or audio data, which may be processed and transmitted to the teleoperator station 110 to facilitate remote operation of the vehicle 102, as further described herein.

The vehicle motion controller 104 may interface or connect with various vehicle systems, e.g., throttle, braking, steering, and/or various peripherals or accessories, to remotely operate the vehicle 102. For example, the vehicle motion controller 104 may comprise one or more sensors to detect or measure drive state information, and/or may receive data from such sensors. In addition, the vehicle motion controller 104 may couple or connect with various vehicle systems, e.g., physically, mechanically, electrically, or otherwise, and provide instructions or commands to enable or cause remote operation of the vehicle 102.

The sensors to detect or measure drive state information of the vehicle 102 may comprise various types of sensors configured to detect speed, acceleration, steering angle, yaw rate, steering torque, and/or other operational characteristics of the vehicle 102. For example, a first sensor such as a speedometer or encoder may measure a drive speed of the vehicle 102, a second sensor such as an accelerometer, pressure sensor, or encoder may measure pedal actuation, acceleration, deceleration, or braking of the vehicle 102, and/or a third sensor such as an encoder or position/orientation sensor may measure a steering angle, yaw rate, steering torque, and/or measure an orientation of the vehicle wheels. The drive state information of the vehicle 102 may be processed and used by the vehicle motion controller 104 to facilitate remote operation of the vehicle 102, as further described herein.

The vehicle motion controller 104 may transmit instructions or commands to various vehicle systems to remotely operate the vehicle 102. For example, the vehicle motion controller 104 may communicate or couple directly with various actuators, subsystems, or systems of the vehicle 102, such as mechanical actuators that directly actuate the vehicle's steering wheel, acceleration pedal, brakes, and/or other systems, components, or peripherals of the vehicle 102. Alternatively, the vehicle motion controller 104 may communicate with existing actuators of the vehicle 102 via one or more electrical interfaces (e.g., for adjusting or controlling speed, acceleration, steering angle, peripheral or accessory functions, and/or other operational characteristics) to control functions or operations of the vehicle 102.

As shown in FIG. 1, an example vehicle teleoperation system 115 may be installed or assembled within the vehicle 102. The vehicle teleoperation system 115 may comprise a single, integrated unit that includes one or more camera interfaces 116, other sensor interfaces, one or more processing islands 117 for video data and/or connectivity data, a connectivity island 118, a safety island 119, and one or more external interfaces 120 that communicate or couple with the vehicle motion controller 104, storage, peripherals, and/or other components or subsystems of the vehicle 102.

In example embodiments, the vehicle teleoperation system 115 may receive, via the camera interfaces 116 and other sensor interfaces, data from various cameras 103 and sensors associated with the vehicle 102. A processing island 117 for video and other sensor data may process the imaging data and other sensor data for transmission to and presentation by a teleoperator station 110. The connectivity island 118 may transmit and receive data to and from the teleoperator station 110 via one or more networks 105, e.g., transmit video and other sensor data to the teleoperator station 110, and receive user input, commands, or instructions from the teleoperator station 110.

Then, a processing island 117 for connectivity data may receive and process the user input, commands, or instructions, and may forward the user input to the safety island 119. The safety island 119 may further process and/or verify the user input, e.g., for accuracy, reliability, integrity, latency, or other aspects, to determine whether to instruct the vehicle 102 based on the received user input. Further, the vehicle teleoperation system 115 may transmit, via the external interfaces 120, user input, commands, instructions, or other data to the vehicle motion controller 104 to remotely operate the vehicle 102, as well as transmit data to storage, peripherals, accessories, or other subsystems of the vehicle 102.

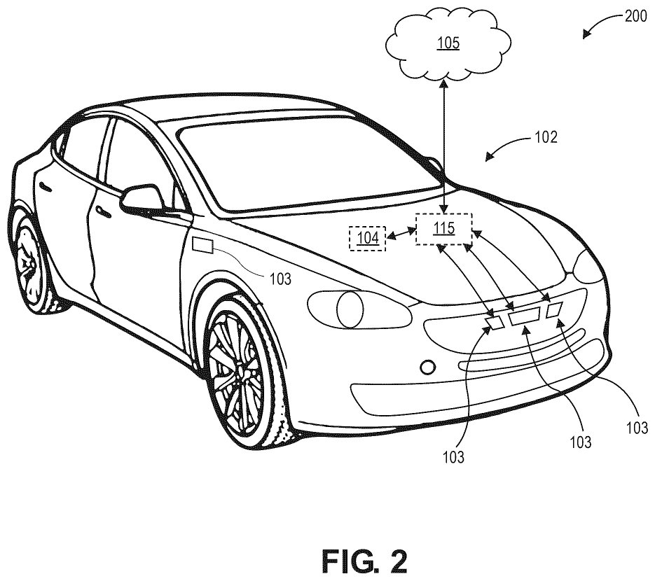

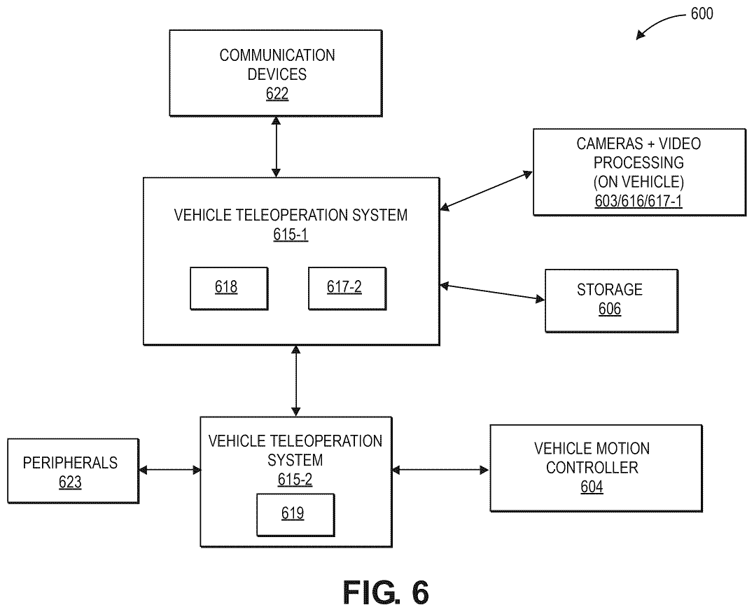

Further details of the portions, components, or subsystems of the vehicle teleoperation system 115 are described herein at least with respect to FIGS. 2-5, and additional example embodiments of the vehicle teleoperation system 115 are described herein at least with respect to FIGS. 6-9.

As further shown in FIG. 1, the wireless communication network 105 may comprise a network that allows for bi-directional transmission of data between the vehicle 102 and the teleoperator station 110. For example, the network 105 may be the Internet, a fourth generation (4G) wireless communication network, a fifth generation (5G) wireless communication network, various cellular or satellite communication networks, or other types of wireless communication networks.

Various data or information may be transmitted via the network 105, including imaging data, audio data, other sensor data, location data, vehicle data, and/or various other data associated with the vehicle 102, e.g., from the vehicle 102 to the teleoperator station 110, as well as drive control inputs, commands, or instructions, and/or other data, information, commands, or instructions, e.g., from the teleoperator station 110 to the vehicle 102 via the wireless communication network 105. For example, processed imaging and/or sensor data may be transmitted from the vehicle 102 via the network 105 to the teleoperator station 110 for presentation by a display, monitor, screen, or other presentation device, e.g., the camera view 112. In addition, various user inputs, commands, or instructions 114 to remotely operate the vehicle 102 may be transmitted from the teleoperator station 110 via the network 105 to the vehicle 102. Further, various additional data may be exchanged between the vehicle 102 and the teleoperator station 110, such as time synchronization or latency information, data transmission timestamps, sequence indicators or identifiers, formatting information, and/or various other data or metadata.

In example embodiments, the teleoperator station 110 may comprise a communication unit configured to send and receive data or information to and from the vehicle 102 via the network 105, one or more processors or processing units configured to process various data such as imaging data, sensor data, user inputs, or others, a presentation or display device, e.g., camera view 112, configured to present, emit, or provide the imaging data, audio data, or other sensor data associated with a vehicle and its environment, and various input devices, e.g., keyboards, mice, touchscreens, touchpads, steering or control wheels, pedals, buttons, knobs, or other user interface elements, configured to receive user inputs, commands, or instructions 114 from the teleoperator using the teleoperator station 110.

The communication unit may comprise various types of communication systems, devices, antenna, interfaces, or other data transmit/receive units configured to enable wireless communication between the teleoperator station 110 and the vehicle 102 via the wireless communication network 105. As described herein, the communication unit may receive imaging data, audio data, other sensor data, location data, vehicle data, and/or various other data from the vehicle 102, and may transmit drive control inputs, commands, or instructions, and/or other data to the vehicle 102.

The processors may comprise one or more processing units, graphics processing units, or other types of processors configured to process the various data that is received and/or sent between the vehicle 102 and teleoperator station 110 via the network 105. For example, the processors may receive and process various imaging data, audio data, or other sensor data from the vehicle 102, and the processors may process and transmit various user inputs, commands, or instructions to the vehicle 102.

In further example embodiments, the teleoperator station 110 may also comprise various components, processors, islands, or other portions similar to the vehicle teleoperation system 115 that is installed within the vehicle 102. For example, the teleoperator station 110 may comprise one or more processing islands for video data and/or connectivity data, a connectivity island, a safety island, and/or one or more external interfaces that communicate or couple with the vehicle 102.

For example, a processing island of the teleoperator station 110 for video and other sensor data may process imaging data and other sensor data that is received from a vehicle teleoperation system 115 of a vehicle 102. A connectivity island of the teleoperator station 110 may receive and transmit data to and from the vehicle teleoperation system 115 of a vehicle 102 via one or more networks 105, e.g., receive video and other sensor data at the teleoperator station 110 from the vehicle teleoperation system 115 of a vehicle 102, and transmit user input, commands, or instructions to the vehicle teleoperation system 115 of a vehicle 102.

Then, a processing island of the teleoperator station 110 for connectivity or user input data may receive and process the user input, commands, or instructions, and may forward the user input to a safety island of the teleoperator station 110. The safety island may further process and/or verify the user input, e.g., for accuracy, reliability, integrity, latency, or other aspects, to determine whether to transmit instructions to the vehicle 102 based on the received user input. Further, the connectivity island of the teleoperator station 110 may transmit, via the external interfaces, user input, commands, instructions, or other data to the vehicle teleoperation system 115 of a vehicle 102 to remotely operate the vehicle 102, e.g., via the vehicle motion controller 104, as well as transmit data to storage, peripherals, accessories, or other subsystems of the vehicle 102.

The processing islands, connectivity islands, safety islands, and/or external interfaces of the teleoperator station 110 may perform any and all of the functions described herein with respect to processing islands 117, connectivity islands 118, safety islands 119, and/or external interfaces 120 of various example embodiments of the vehicle teleoperation systems 115 presented and described herein. In addition, various of the functions or operations may be split, divided, shared, or otherwise distributed among the various islands of the example teleoperator stations 110 and example vehicle teleoperation systems 115.

Further details of the portions, components, or subsystems of various processing islands, connectivity islands, safety islands, and/or external interfaces of the teleoperator station 110 are described herein at least with respect to FIGS. 2-5, and additional example embodiments of the vehicle teleoperation system 115 that is in communication with the teleoperator station 110 are described herein at least with respect to FIGS. 6-9.

The camera view 112 may comprise one or more monitors, screens, projectors, display devices, head-mounted displays, augmented reality displays, other types of presentation devices, speakers, audio output devices, haptic feedback or output devices, and/or other types of feedback or output devices. For example, the camera view 112 may receive and present, render, or display the imaging data, e.g., video data or live video streams, received from the vehicle 102. In addition, the camera view 112 may receive and emit sounds or other audio data associated with objects in a vehicle's environment. Moreover, the camera view 112 may emit various other information, indicators, or feedback, e.g., visual, audio, haptic, or other types of feedback, based on the received sensor data. The camera view 112 may present, emit, or provide the various imaging data, audio data, information, feedback, or indicators, such that a teleoperator at the teleoperator station 110 may have an awareness of the vehicle 102 and an environment around the vehicle 102 in order to remotely operate the vehicle 102.

The input devices may comprise a steering wheel, acceleration pedal, brake pedal, transmission selector, and/or various other interface components to generate drive control inputs or commands 114 for the vehicle 102. In addition, the input devices may include components, elements, or interfaces to control or instruct various other aspects of the vehicle 102, such as lights, turn indicators, windshield wipers, power windows, power doors, climate control systems, entertainment or infotainment systems, and/or various other systems, devices, or accessories associated with the vehicle 102. The input devices may receive drive control inputs, commands, or instructions 114 provided or input by a teleoperator at the teleoperator station 110, which may then be processed and/or transmitted to the vehicle 102 via the network 105 in order to remotely operate the vehicle 102.

Although FIG. 1 illustrates an example remote driving system having a particular number, type, configuration, and arrangement of various components, other example embodiments may include various other numbers, types, configurations, and arrangements of the various components. For example, vehicles may have various numbers, types, configurations, or arrangement of cameras, sensors, or vehicle motion controllers, vehicles may have various example embodiments of vehicle teleoperation systems described herein, one or more vehicles may be in communication with one or more teleoperator stations, various types of wireless communication networks may be used to facilitate communication between vehicles and teleoperator stations, and/or various other modifications may be made in other example embodiments of the example remote driving system.

FIG. 2 is a schematic diagram 200 of a vehicle including an example vehicle teleoperation system, in accordance with implementations of the present disclosure. The example vehicle 102 illustrated in FIG. 2 may include any and all of the features of the vehicle 102 described herein at least with respect to FIG. 1.

For example, the vehicle 102 may include various types of sensors to detect or capture data associated with various objects or portions of an environment around the vehicle, including one or more imaging devices, cameras, or sensors 103 for capturing imaging data of the vehicle's environment, and/or one or more audio sensors or arrays, radar sensors, LIDAR sensors, or other types of sensors for detecting or capturing data associated with the vehicle's environment.

In example embodiments, the imaging devices or cameras 103 associated with the vehicle 102 may comprise various types of imaging sensors, analog cameras, digital cameras, video cameras, depth sensors, infrared sensors, time-of-flight sensors, or other types of imaging sensors. The imaging devices or cameras 103 may be positioned and oriented at various positions on the vehicle 102 in order to capture imaging data of an environment at least partially around the vehicle 102, e.g., towards a forward movement direction, towards a rearward movement direction, and/or toward various other portions of a periphery of the vehicle 102. In addition, the imaging devices or cameras may capture imaging data, such as video data, live video streams, or other types of imaging data, which may be transmitted to the teleoperator station 110 and used to facilitate remote operation of the vehicle 102, as further described herein.

In the example of FIG. 2, the imaging devices 103 may be positioned toward a forward portion of the vehicle 102 in order to capture imaging data of an environment toward a forward movement direction of the vehicle 102, and some imaging devices 103 may be positioned toward a side portion of the vehicle 102 in order to capture imaging data of an environment toward one or more sides of the vehicle 102. Although not illustrated in FIG. 2, various additional imaging devices may be positioned at other portions of the vehicle 102 to capture imaging data of the environment toward other directions relative to the vehicle, e.g., toward a rearward movement direction, toward lateral sides or corners of the vehicle, or any other directions.

Furthermore, imaging data that is captured by the imaging devices 103 may be processed to identify objects, and also to identify locations of objects within the imaging data relative to the vehicle 102. For example, the relative locations of objects within imaging data may be determined based on known positions, orientations, and fields of view of the imaging devices 103 relative to the vehicle.

In example embodiments, audio sensors or arrays associated with the vehicle 102 may comprise various types of microphones, microphone arrays, audio transducers, piezoelectric elements, and/or other types of audio sensors. The audio sensors or arrays may be positioned and oriented at various positions on the vehicle 102, similar to the positions and orientations of the imaging devices 103, in order to detect and capture audio data of an environment at least partially around the vehicle 102, e.g., towards a forward movement direction, towards a rearward movement direction, and/or toward various other portions of a periphery of the vehicle 102. In addition, the audio sensors or arrays may capture audio data, such as voices, speech, footsteps, bicycles, tire or road noise, vehicles, engines, motors, or other types of sounds or audio data, which may be transmitted to the teleoperator station 110 and used to facilitate remote operation of the vehicle 102, as further described herein.

Furthermore, audio data that is captured by an audio sensor array or microphone array may be processed to identify sounds, and also to identify locations of objects associated with the sounds in the environment relative to the vehicle 102. For example, the relative locations of objects in the environment may be determined based on known positions and orientations of individual audio sensors or microphones of an array relative to the vehicle, as well as relative times of receipt of audio data by the individual audio sensors or microphones of an array.

In example embodiments, various other sensors associated with the vehicle 102 may comprise various types of depth sensors, radar sensors, LIDAR sensors, or other types of time-of-flight sensors. The sensors may also be positioned and oriented at various positions on the vehicle 102, similar to the positions and orientations of the imaging devices 103, in order to capture data of an environment at least partially around the vehicle 102, e.g., towards a forward movement direction, towards a rearward movement direction, and/or toward various other portions of a periphery of the vehicle 102. In addition, the sensors may capture various types of data, which may be transmitted to the teleoperator station 110 and used to facilitate remote operation of the vehicle 102, as further described herein.

Furthermore, data that is captured by the other sensors may be processed to identify distances or ranges to objects, and also to identify locations of objects within the data relative to the vehicle 102. For example, the relative locations of objects within the data may be determined based on known positions, orientations, and fields of sensing or view of the sensors relative to the vehicle.

In addition, as shown in FIG. 2, the vehicle 102 may include a vehicle motion controller 104 that is configured to interface with various vehicle systems to control functions and operations of the vehicle 102, including throttle, braking, steering, and various peripherals or accessories. Generally, vehicle motion controllers 104 may be specific or specialized for particular vehicle types or vehicle platforms. For example, a first vehicle or component manufacturer may design and manufacture a first vehicle motion controller that is specialized for particular first vehicles or platforms, whereas a second vehicle or component manufacturer may design and manufacture a second vehicle motion controller that is specialized for particular second vehicles or platforms. As a result, different vehicle motion controllers may require or receive different types, attributes, formatting, software, specifications, or other aspects related to user inputs, commands, or instructions that may be generated and received from teleoperator stations to remotely operate respective vehicles.

In example embodiments, the vehicle 102 may also comprise an example vehicle teleoperation system 115 that is installed or assembled in the vehicle 102. The vehicle teleoperation system 115 may communicate or interface with the various imaging sensors or devices 103, audio sensors, or other types of sensors onboard the vehicle 102. For example, the vehicle teleoperation system 115 may receive various sensor data, process the sensor data, and then transmit the processed sensor data to a teleoperator station via one or more networks 105.

In addition, the vehicle teleoperation system 115 may communicate or interface with the vehicle motion controller 104 that is present onboard the vehicle 102. In order to effectively communicate with the vehicle motion controller 104, the vehicle teleoperation system 115 may be provisioned, configured, adapted, or modified based on the vehicle, vehicle type, class, make, model, software, or other attributes, characteristics, or aspects of the vehicle 102. For example, the vehicle teleoperation system 115 may receive user inputs, commands, or instructions from a teleoperator station via one or more networks 105, process, provision, adapt, and/or verify the user inputs, and then forward the user inputs to the vehicle motion controller 104 to instruct remote operation of the vehicle 102.

Although FIG. 2 illustrates an example vehicle having a particular number, type, configuration, and arrangement of various components, other example embodiments may include various other numbers, types, configurations, and arrangements of the various components. For example, vehicles may have various numbers, types, configurations, or arrangement of cameras, sensors, or vehicle motion controllers, vehicles may have various example embodiments of vehicle teleoperation systems described herein, various types of wireless communication networks may be used to facilitate communication between vehicles and teleoperator stations, and/or various other modifications may be made in other embodiments of the example vehicle.

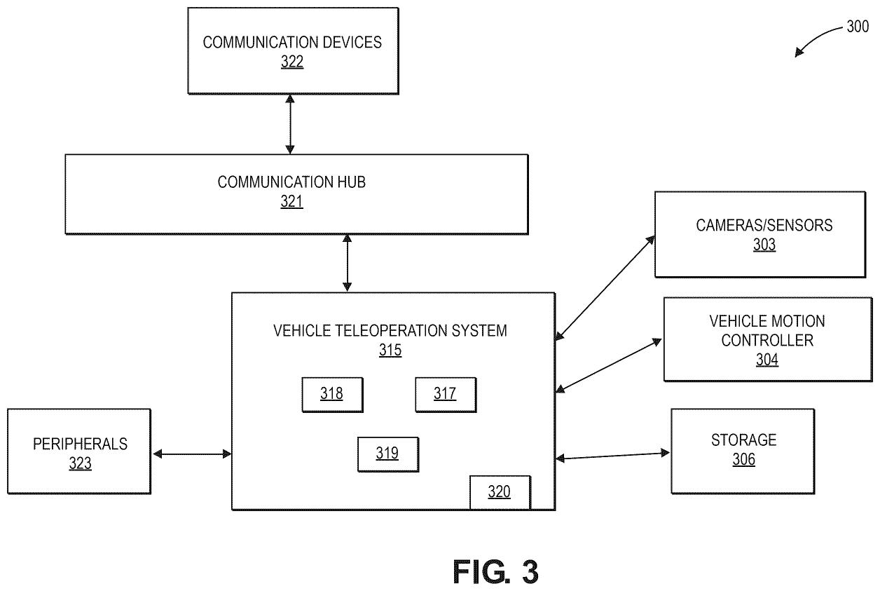

FIG. 3 is a schematic diagram 300 of a first example embodiment of a vehicle teleoperation system, in accordance with implementations of the present disclosure.

As shown in FIG. 3, a vehicle teleoperation system 315 may be installed or assembled within a vehicle, and the vehicle teleoperation system 315 may be operatively coupled to one or more cameras or sensors 303, a vehicle motion controller 304, storage 306, a communication hub 321 and one or more communication devices 322, and/or one or more peripherals 323. In addition, the vehicle teleoperation system 315 may comprise one or more processing islands 317 for video data and/or connectivity data, a connectivity island 318, a safety island 319, and one or more interfaces to cameras, sensors, a vehicle motion controller, communication devices, storage, and/or peripherals or accessories.

The processing islands 317 may comprise various processors, chips, cores, microcontrollers, applications, or other hardware and/or software configured to process imaging data, video data, audio data, or other sensor data received via one or more sensor data interfaces. The sensor data may be captured by various cameras, audio sensors, or other sensors 303 that may be associated with a vehicle, as further described herein, and may be transmitted to the processing islands 317 via the sensor data interfaces. The various sensor data interfaces, e.g., video, audio, or other sensor data, may transmit or receive data using various data communication standards, interfaces, or protocols, such as CAN (controller area network) buses, USB (universal serial bus), automotive ethernet, and/or other standards.

In addition, the processing islands 317 may process the various sensor data using various applications, models, techniques, or algorithms. For example, imaging data or other sensor data may be processed to select or highlight particular portions of the data. In addition, imaging data or other sensor data may be filtered, cleaned, or compressed to prepare the data for transmission to and presentation by one or more teleoperator stations. Further, the imaging data or other sensor data may be processed or prepared for transmission using adaptive bitrate encoding, region of interest encoding, dynamic resolution rendering, or other streaming techniques. The processing islands 317 may be configured to perform various other processing to facilitate preparation of imaging data and other sensor data for transmission to and presentation by a teleoperator station.

In some additional example embodiments, the imaging data or other sensor data that is processed by the processing islands 317 may be provided or transmitted to one or more other systems, devices, processors, control units, or peripherals associated with the vehicle to enable various additional functions or operations. For example, the imaging and other sensor data may be provided to an onboard ADAS (advanced driver assistance system) via an external interface 320 to perform various other vehicle functions or operations based on the imaging or sensor data. In addition, the imaging and other sensor data may be provided or transmitted to other remote systems, e.g., a teleoperator station, via an external interface 320 in order to generate control inputs or commands based on the imaging or sensor data.

The connectivity island 318 may comprise various processors, chips, cores, microcontrollers, applications, or other hardware and/or software configured to transmit and/or receive data between the vehicle teleoperation system and one or more teleoperator stations via one or more networks. In addition, the connectivity island 318 may be configured to provide or ensure encryption or security of data that is transmitted, as well as provide or perform decryption of data that is received. Moreover, the connectivity island 318 may be configured to detect or measure round-trip time, packet-loss of data, and available bandwidth using different modems and networks, and/or detect or measure various other aspects of data transmission and/or receipt. The connectivity island 318 may be configured to perform various other processing to facilitate communication of data between a teleoperator station and the vehicle teleoperation system.

Further, the connectivity island 318 may comprise or be operatively connected to one or more communication devices 322, e.g., via a communication hub 321. The communication devices 322 may comprise various numbers or types of modems, e.g., two modems, four modems, or other numbers of modems. Each of the various modems may be configured to communicate between the vehicle and one or more teleoperator stations via various communication networks. For example, each modem may communicate using respective communication networks that are operated by different mobile or communication network operators or providers. The connectivity island 318 may transmit or receive data to or from the communication devices 322 via the communication hub 321 using various data communication standards, interfaces, or protocols, such as CAN buses, USB, PCIe (peripheral component interconnect express), automotive ethernet, and/or other standards.

Generally, different communication networks may have different data transmission, data reception, and other operational characteristics over time, such as bandwidth, latency, or other transmission or reception aspects or attributes. In some examples, the same data, information, or commands may be transmitted and/or received substantially simultaneously using the multiple modems, and data that is transmitted and/or received with the lowest latency and/or greatest accuracy or integrity may be selected for use by the teleoperator station and/or the vehicle teleoperation system, e.g., in order to optimize for latency, accuracy, and/or safety of remote operation.

Furthermore, the processing islands 317 may also comprise various processors, chips, cores, microcontrollers, applications, or other hardware and/or software configured to receive and process connectivity data, such as user inputs, commands, or instructions for remote operation of the vehicle. The user inputs, commands, or instructions may be captured or received by various user interface elements associated with a teleoperator station while presenting or providing the imaging data and other sensor data received from the vehicle teleoperation system, which are associated with current operations and environment of the vehicle.

In addition, the processing islands 317 may process the various connectivity data using various applications, models, techniques, or algorithms. For example, user inputs, commands, or instructions may be processed to determine appropriate or corresponding commands or instructions for various vehicle systems. In addition, the processing islands 317 may transmit or forward the user inputs, and/or corresponding commands or instructions, to the safety island 319 for verification or validation. The processing islands 317 may be configured to perform various other processing to facilitate preparation and transmission of user inputs, commands, or instructions for verification by the safety island 319. Furthermore, the processing islands 317 may be configured to perform health management or life-cycle management of software and hardware components, telemetry aggregation and ingestion, over-the-air updates, and other functions which may be necessary for safe operation of a remote vehicle. In some examples, some or all of the processing performed by the safety island 319, as further described herein, may also be performed by the processing islands 317, or vice versa.

The safety island 319 may comprise various processors, chips, cores, microcontrollers, applications, or other hardware and/or software configured to receive and process user inputs, commands, or instructions, e.g., to check, verify, and validate the user inputs. The user inputs, commands, or instructions may be received by the safety island 319 from a teleoperator station via the connectivity island 318 and the processing islands 317, and the safety island 319 may transmit commands or instructions to the vehicle motion controller 304, storage 306, peripherals 323, and/or other components via external data interfaces. The various external data interfaces may transmit or receive data using various data communication standards, interfaces, or protocols, such as CAN buses, USB, automotive ethernet, and/or other standards.

The safety island 319, potentially in combination with the processing islands 317, may process, analyze, verify, or validate the user inputs. For example, the safety island 319 may verify that the received user inputs are expected or appropriate commands or instructions, e.g., by checking or verifying latency of the received inputs, by compensating for detected latency, by checking timestamps of the received inputs, by determining or verifying a sequence of received inputs, and/or by verifying integrity, accuracy, completeness, or logical consistency of the received inputs. In addition, the safety island 319 may provision, adapt, or format the received inputs for transmission to and execution by a vehicle motion controller 304, e.g., based on vehicle type, class, make, model, or other vehicle attributes. Further, the safety island may prevent or disallow erroneous or erratic inputs, may apply limits to instructed actions based on the received inputs, and/or may perform various other checks, processing, or verification of the user inputs. Furthermore, the safety island may request, instruct, or cause performance of various safety maneuvers, such as reducing a speed of the vehicle, stopping the vehicle, performing a safety pull-over of the vehicle, or other maneuvers to ensure, maintain, or increase safety of the vehicle and its operations.

As a result, the safety island 319, potentially in combination with the processing islands 317, may ensure that safe, accurate, and appropriate commands or instructions are provided or transmitted to the vehicle motion controller 304 of a vehicle, by performing various checks or verifications of the inputs, commands, or instructions received from a teleoperator station as described herein.

In addition, the safety island 319 may transmit various data or information to peripherals 323 via various external data interfaces, which may comprise lights, turn signals, windshield wipers, door and window controls, HVAC (heating, ventilation, and air conditioning) systems, infotainment systems, and/or various other peripherals or accessories of a vehicle. Similar to the received commands or instructions related to remote driving of the vehicle, the commands or instructions related to operations of various peripherals may be received from the teleoperator station as user inputs, and may be processed, provisioned, adapted, formatted, checked, or verified by the safety island 319 as described herein.

Further, the safety island 319 may transmit various data or information to storage 306 via various external data interfaces, which may comprise various memories, flash storage, video logs, data logs, or other data storage. The data stored within storage 306 may be utilized for various purposes, including improvements or updates to the vehicle teleoperation system, analysis of video data, vehicle commands, or other actions, improvements to the remote driving system, and/or other purposes.

As shown in FIG. 3, the example vehicle teleoperation system 315 including processing islands 317, connectivity island 318, and safety island 319 may comprise a single, integrated chip or processing unit having multiple cores, microprocessors, applications, and/or other hardware and/or software to implement the functions and operations described herein with respect to each of the processing islands 317, connectivity island 318, and safety island 319.

Using the example vehicle teleoperation systems described herein, imaging, video, or other sensor data captured by various sensors associated with a vehicle may be received, processed, and transmitted to a teleoperator station for presentation to a teleoperator. Then, various user inputs, commands, or instructions provided by the teleoperator at the teleoperator station may be received, processed, provisioned, adapted, verified, and transmitted to a vehicle motion controller associated with the vehicle, as well as various peripherals or accessories of the vehicle. In this manner, the example vehicle teleoperation system that comprises a single, integrated unit installed within the vehicle may enable safe, accurate, and reliable remote operation of a vehicle.

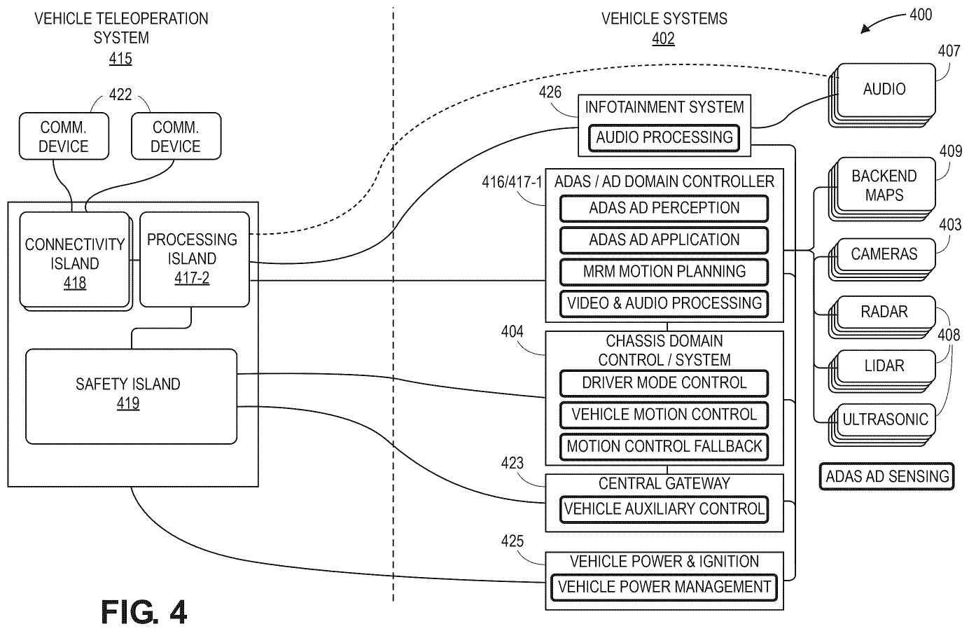

Although the example embodiment of FIG. 3 illustrates a vehicle teleoperation system that is installed within a vehicle having cameras, sensors, and vehicle motion controller, other example embodiments may relate to vehicle teleoperation systems that are installed within vehicles having different existing equipment than that shown in FIG. 3. For example, some vehicles may not include any existing onboard sensors, other vehicles may include one or more onboard sensors of various types, further vehicles may include onboard sensors as well as onboard sensor processing units, still further vehicles may not include onboard vehicle motion controllers, and/or additional vehicles may have other configurations or combinations of onboard, existing equipment. Thus, various other example embodiments of a vehicle teleoperation system that may be installed within vehicles having various configurations or combinations of onboard equipment are described herein at least with respect to FIGS. 4-9.

Generally, the example vehicle teleoperation systems described herein may comprise various processors, chips, cores, microcontrollers, applications, or other hardware and/or software that are configured to receive video or other sensor data associated with a vehicle's environment, transmit the processed sensor data to a teleoperator station, receive user inputs from a teleoperator at the teleoperator station, and transmit the processed user inputs to a vehicle motion controller associated with the vehicle.

For example embodiments in which a vehicle includes various onboard cameras or sensors, the example vehicle teleoperation system may operatively connect with the onboard cameras or sensors to receive sensor data, and may process the sensor data for transmission to a teleoperator station. In addition, if the vehicle also includes various onboard sensor data processing units, the example vehicle teleoperation system may operatively connect with the onboard sensor data processing units to receive the processed sensor data, and then transmit such data to a teleoperator station. Alternatively, if the vehicle does not include any onboard cameras, sensors, or sensor data processing units, the example vehicle teleoperation system may further include various cameras, sensors, and sensor data processing units, e.g., processing islands, that can be installed within the vehicle to capture and process data related to a vehicle's environment to enable remote operations.

Similarly, for example embodiments in which a vehicle includes an onboard vehicle motion controller, the example vehicle teleoperation system may operatively connect with the onboard vehicle motion controller to transmit vehicle commands or instructions that are received, processed, and provisioned from a teleoperator at a teleoperator station. Alternatively, if the vehicle does not include an onboard vehicle motion controller, the example vehicle teleoperation system may further include a vehicle motion controller that can be installed within the vehicle to operatively couple with and provide instructions to various vehicle drive systems, peripherals, and/or accessories to enable remote operations of the vehicle.

FIG. 4 is a schematic diagram 400 of a first example platform for an example vehicle teleoperation system, in accordance with implementations of the present disclosure.

As shown in FIG. 4, a first example platform for an example vehicle teleoperation system 415 may comprise a processing island 417-2 for connectivity data, a connectivity island 418 and one or more communication devices 422, and a safety island 419. As described herein, the connectivity island 418 may transmit video and other sensor data to a teleoperator station using the communication devices 422, and may receive user inputs from a teleoperator at the teleoperator station. The processing island 417-2 may receive and forward video and sensor data from a vehicle to the connectivity island 418, and may receive and process the user inputs for transmission to the safety island 419. Further, the safety island 419 may process, provision, or verify the user inputs for transmission to a vehicle motion controller of the vehicle.

In this first example platform, the vehicle may comprise various vehicle systems 402, including various sensors 403, 407, 408, 409, various sensor data interfaces and processing units 416, 417-1, 426, a vehicle motion controller 404, various peripherals or accessories 423, and a vehicle power controller 425. Because the example vehicle of FIG. 4 includes various onboard cameras, sensors, sensor data processing units, and vehicle motion controller, the example vehicle teleoperation system 415 of the first example platform may not include or require additional or redundant cameras, sensors, sensor data processing units, and vehicle motion controller. As a result, the example vehicle teleoperation system 415 of the first example platform may operatively couple to and communicate with the existing onboard systems 402 of the vehicle, e.g., at least the onboard cameras, sensors, sensor data processing units, and vehicle motion controller.

The various sensors of the vehicle may comprise cameras 403, audio sensors 407, radar, LIDAR, ultrasonic, or other time of flight sensors 408, and/or backend maps and location sensors 409. For example, the cameras 403 may comprise various types of imaging devices or sensors, including optical, infrared, depth, or other types of imaging devices. The audio sensors 407 may comprise microphones, arrays, audio transducers, piezoelectric elements, or other types of audio sensors. The time of flight sensors 408 may comprise various range, distance, or proximity sensors. The location sensors 409 may comprise various GPS (global positioning system) receivers, GNSS (global navigation satellite system) receivers, local position sensors, or other types of location sensors.

The various sensor data interfaces and processing units may comprise an ADAS/AD (advanced driver assistance system/autonomous driving) domain controller 416/417-1 and an infotainment system 426. The ADAS/AD domain controller may comprise various sensor data interfaces 416 and sensor data processing units 417-1 that are configured to receive and process the various sensor data, e.g., imaging data from cameras 403 and time of flight data from various sensors 408, potentially in combination with mapping and location data from location sensors 409. For example, the ADAS/AD domain controller may receive sensor data, perform sensor fusion on the received data, and process the data to determine and execute various ADAS functions or operations, such as adaptive cruise control, lane departure warnings, automated braking assistance, or other related driver assistance functions. In addition, the ADAS/AD domain controller may identify or determine minimum risk maneuvers (MRM), such as safe stop or control and stop maneuvers in response to various issues. Further, the ADAS/AD domain controller may transmit processed sensor data to the vehicle teleoperation system 415.

In addition, the infotainment system 426 may comprise various sensor data interfaces and sensor data processing units that are configured to receive and process the various audio data from audio sensors 407. For example, the infotainment system 426 may receive and process audio data from inside or outside the vehicle, e.g., speech or audio data from a passenger or generally inside a vehicle cabin, or sounds from an environment around the vehicle. In addition, the infotainment system 426 may also include speakers or other audio output devices to provide audio feedback, information, or sounds to a passenger within the vehicle or to individuals in an environment around the vehicle. Further, the infotainment system may transmit processed audio data to the vehicle teleoperation system 415.

The vehicle motion controller may comprise a chassis domain control/system 404 that is configured to receive commands or instructions from the vehicle teleoperation system 415, and execute the commands as vehicle motion control, e.g., using throttle, braking, steering, or other vehicle control systems or functions. In some examples, the chassis domain control/system may also include a motion control fallback, e.g., a redundant or backup motion controller, that may be utilized in case of issues or faults with a primary vehicle motion controller. In addition, some vehicles may comprise different driver mode controls, e.g., sport, economy, normal, or other drive modes, which may influence or affect execution of various vehicle commands or instructions. Various functions or operations described herein may be shared or distributed between the ADAS/AD domain controller 416/417-1 and the chassis domain control/system 404.

The various peripherals or accessories may comprise a central gateway 423 that is configured to facilitate vehicle auxiliary or peripheral control. For example, various peripherals or accessories, such as lights, turn signals, windshield wipers, door and window controls, HVAC systems, infotainment systems, and/or various other peripherals or accessories of a vehicle, may be controlled or instructed based on commands received from the vehicle teleoperation system 415.

The vehicle power controller may comprise a vehicle power and ignition control 425 that is configured to control provision or removal of power to various systems, including ignition, engine, motors actuators, vehicle motion controller, peripherals, accessories, and various other vehicle systems and functions described herein. Further, the vehicle power controller may manage power to various vehicle systems based on commands received from the vehicle teleoperation system 415.

As described herein, the example vehicle of FIG. 4 includes various onboard cameras, sensors, sensor data processing units, and vehicle motion controller. Thus, the vehicle teleoperation system 415 of the first example platform may not include or require additional or redundant cameras, sensors, sensor data processing units, and vehicle motion controller, and may operatively couple to and communicate with the existing onboard systems 402 of the vehicle, e.g., at least the onboard cameras, sensors, sensor data processing units, and vehicle motion controller.

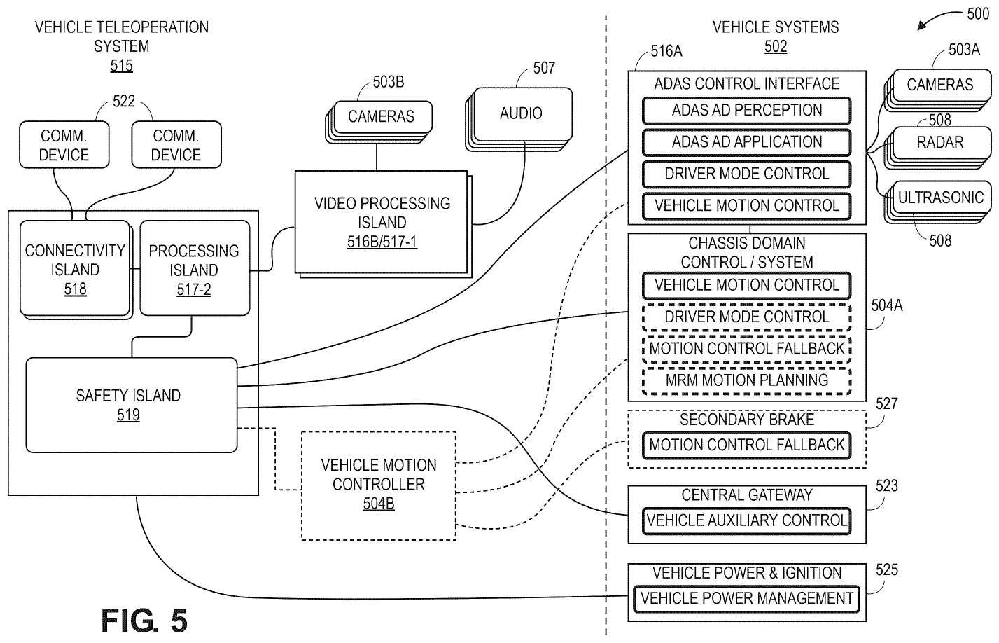

FIG. 5 is a schematic diagram 500 of a second example platform for an example vehicle teleoperation system, in accordance with implementations of the present disclosure.

As shown in FIG. 5, a second example platform for an example vehicle teleoperation system 515 may comprise a processing island 517-2 for connectivity data, a connectivity island 518 and one or more communication devices 522, and a safety island 519. As described herein, the connectivity island 518 may transmit video and other sensor data to a teleoperator station using the communication devices 522, and may receive user inputs from a teleoperator at the teleoperator station. The processing island 517-2 may receive and forward video and sensor data from a vehicle to the connectivity island 518, and may receive and process the user inputs for transmission to the safety island 519. Further, the safety island 519 may process, provision, or verify the user inputs for transmission to a vehicle motion controller of the vehicle.

In this second example platform, the vehicle may comprise various vehicle systems 502, including all or a subset of various sensors 503A, 508, various sensor data interfaces and processing units 516A, a vehicle motion controller 504A, various peripherals or accessories 523, a vehicle power controller 525, and a secondary brake 527. In various examples described herein, the example vehicle of FIG. 5 may not include onboard cameras, sensors, or sensor data processing units, and/or may not include a vehicle motion controller. As a result, the example vehicle teleoperation system 515 of the second example platform may include or require cameras 503B, sensors 507, video processing island 516B, 517-1, and/or vehicle motion controller 504B. In addition, the example vehicle teleoperation system 515 of the second example platform may operatively couple to and communicate with other existing onboard systems 502 of the vehicle.

The various sensors of the vehicle may comprise cameras 503A, and radar, ultrasonic, or other time of flight sensors 508. The various sensors onboard the vehicle may be similar to those sensors described herein at least with respect to FIG. 4. The various sensor data interfaces and processing units may comprise an ADAS (advanced driver assistance system) control interface 516A. The ADAS control interface 516A may be similar to the ADAS domain controller described herein at least with respect to FIG. 4. In addition or alternatively, the ADAS control interface 516A may include a vehicle motion control to execute vehicle commands, e.g., using throttle, braking, steering, or other vehicle control systems or functions.

The vehicle motion controller may also comprise a chassis domain control/system 504A that is configured to receive commands or instructions from the vehicle teleoperation system 515, and execute the commands as vehicle motion control, e.g., using throttle, braking, steering, or other vehicle control systems or functions. The chassis domain control/system 504A may be similar to the chassis domain control/system described herein at least with respect to FIG. 4. In addition or alternatively, various functions or operations illustrated in dashed lines in FIG. 5 may be optional or absent from the chassis domain control/system 504A, and/or may be optionally included in the chassis domain control/system 504A, such as MRM motion planning. As set forth herein, various functions or operations described herein may be shared or distributed between the ADAS control interface 516A and the chassis domain control/system 504A.

The various peripherals or accessories may comprise a central gateway 523 that is configured to facilitate vehicle auxiliary or peripheral control. The various peripherals or accessories of the vehicle may be similar to those peripherals described herein at least with respect to FIG. 4. The vehicle power controller may comprise a vehicle power and ignition control 525 that is configured to control provision or removal of power to various systems, including ignition, engine, motors actuators, vehicle motion controller, peripherals, accessories, and various other vehicle systems and functions described herein. The vehicle power controller may be similar to that described herein at least with respect to FIG. 4.

In a first embodiment of the second example platform of FIG. 5, the vehicle systems 502 may not include cameras 503A, sensors 508, and various sensor data interfaces of the ADAS control interface 516A. In the absence of such systems onboard a vehicle, the example vehicle teleoperation system 515 may include or provide cameras 503B, audio sensors 507, and/or a video processing island 516B, 517-1. As described herein, the cameras 503B may capture imaging or video data of an environment around a vehicle, audio sensors 507 may capture sounds, speech, or other audio data of passengers, inside a cabin of the vehicle, and/or around an environment of the vehicle, and the video processing island may receive the video and other sensor data via sensor data interfaces 516B and process such data using the video processing island 517-1.

Then, the processed video and other sensor data may be transmitted from the video processing island 517-1 to the connectivity island 518 via the processing island 517-2, in order to be transmitted to a teleoperator station for presentation to a teleoperator. Upon receiving user inputs from the teleoperator at the teleoperator station, the user inputs may be received by the connectivity island 518, processed by the processing island 517-2, verified, provisioned, or checked by the safety island 519, and then transmitted to vehicle motion control portions of the ADAS control interface 516A and/or the chassis domain control/system 504A, which may substantially function as a vehicle motion controller onboard the vehicle.

In a second embodiment of the second example platform of FIG. 5, the vehicle systems 502 may not include vehicle motion control portions of the ADAS control interface 516A and/or the chassis domain control/system 504A. In the absence of a vehicle motion controller onboard a vehicle, the example vehicle teleoperation system 515 may include or provide a vehicle motion controller 504B that is operatively coupled to and in communication with the vehicle teleoperation system 515, and the vehicle motion controller 504B may be operatively coupled to various vehicle systems 502 of the vehicle, as illustrated by dashed lines in FIG. 5.

Although the vehicle motion controller 504B is illustrated in FIG. 5 as being in communication with the ADAS control interface 516A and/or the chassis domain control/system 504A, these systems 516A, 504A may be substantially absent onboard the vehicle, and the vehicle motion controller 504B may instead be substantially directly coupled to various vehicle drive systems, e.g., throttle, braking, steering, and other related drive systems or functions, that are associated with the vehicle. In further examples, the vehicle motion controller 504B may also be coupled to and in communication with the secondary brake 527 to provide motion control fallback, e.g., a redundant or backup motion controller, that may be utilized in case of issues or faults with the vehicle motion controller 504B.

As described herein, the example vehicle of FIG. 5 may not include onboard cameras, sensors, sensor data processing units, and/or vehicle motion controller. Thus, the vehicle teleoperation system 515 of the second example platform may include or require additional cameras, sensors, sensor data processing units, and/or vehicle motion controller, and may operatively couple to and communicate with other existing onboard systems 502 of the vehicle, e.g., drive systems, peripherals, accessories, power, or others.

FIG. 6 is a schematic diagram 600 of a second example embodiment of a vehicle teleoperation system, in accordance with implementations of the present disclosure.

As shown in FIG. 6, the second example embodiment of a vehicle teleoperation system may comprise cameras or sensors 603, vehicle motion controller 604, storage 606, communication devices 622, and peripherals 623 that are substantially the same as those components described herein at least with respect to FIG. 3.

In contrast to the description of FIG. 3, one or more sensor data interfaces 616 and video processing units 617-1 may also be present onboard the vehicle, together with the cameras or sensors 603. Furthermore, in contrast to the description of FIG. 3, the vehicle teleoperation system 615 may be formed or developed as two portions 615-1, 615-2 upon two separate but physically, electrically, and/or functionally connected chips. For example, a first portion 615-1 of the vehicle teleoperation system may comprise a processing island 617-2 for connectivity data and a connectivity island 618, and a second portion 615-2 of the vehicle teleoperation system may comprise a safety island 619. The functions or operations of the processing island 617-2, connectivity island 618, and safety island 619 may be substantially the same as those components described herein at least with respect to FIGS. 3-5.

In the second example embodiment illustrated in FIG. 6, the cameras or other sensors 603, the video or other sensor data interfaces 616, and sensor data processing units 617-1 may be positioned onboard the vehicle. As a result, the vehicle teleoperation system 615 may not include or require additional sensors, sensor data interfaces, or sensor data processing islands, thereby simplifying at least the first portion 615-1 of the vehicle teleoperation system. The first portion 615-1 may receive the processed sensor data from the vehicle's onboard sensor data processing units 617-1, and may forward or transmit the processed sensor data to a teleoperator station via the processing island 617-2 and connectivity island 618.

Moreover, by forming or developing the vehicle teleoperation system as two portions 615-1, 615-2, the cost and complexity of the single chip described with respect to the first example embodiment of FIG. 3 may be reduced, as two separate, relatively lower cost, and potentially simpler chips may be used for each of the two portions 615-1, 615-2. In addition, developing the processing island 617-2 and connectivity island 618 on a first portion 615-1, and developing the safety island 619 on a second portion 615-2 may reduce, mitigate, or uncouple potential issues or problems associated with one portion, while maintaining functions or operations associated with the other portion. However, various issues or problems may be increased or added by utilizing multiple portions or chips 615-1, 615-2, due to the additional components, parts, connections, or other aspects.

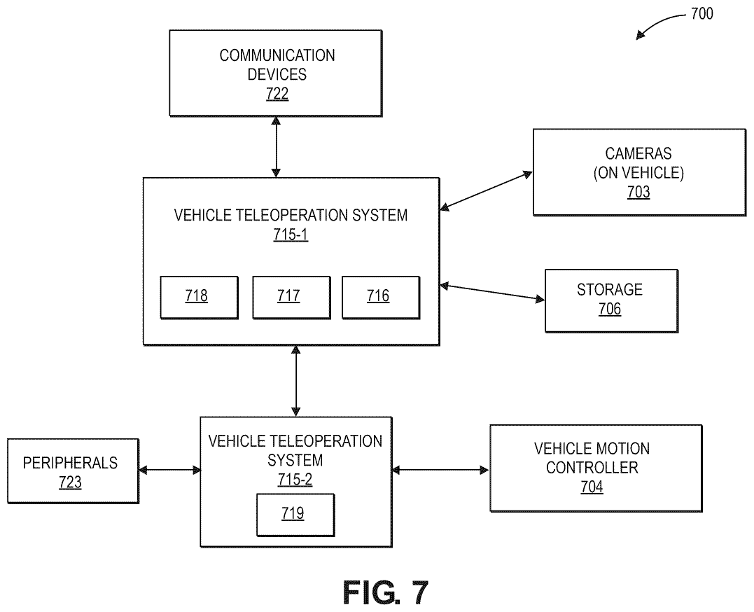

FIG. 7 is a schematic diagram 700 of a third example embodiment of a vehicle teleoperation system, in accordance with implementations of the present disclosure.

As shown in FIG. 7, the third example embodiment of a vehicle teleoperation system may comprise cameras or sensors 703, vehicle motion controller 704, storage 706, communication devices 722, and peripherals 723 that are substantially the same as those components described herein at least with respect to FIGS. 3 and 6.

In contrast to the description of FIG. 6, one or more cameras or sensors 703 may be present onboard the vehicle, and various sensor data interfaces 716 and processing islands 717 for video or sensor data and connectivity data may be included within the vehicle teleoperation system 715. Furthermore, similar to the description of FIG. 6, the vehicle teleoperation system 715 may be formed or developed as two portions 715-1, 715-2 upon two separate but physically, electrically, and/or functionally connected chips. For example, a first portion 715-1 of the vehicle teleoperation system may comprise various sensor data interfaces 716, processing islands 717 for video or sensor data and connectivity data, and a connectivity island 718, and a second portion 715-2 of the vehicle teleoperation system may comprise a safety island 719. The functions or operations of the processing islands 717, connectivity island 718, and safety island 719 may be substantially the same as those components described herein at least with respect to FIGS. 3-6.

In the third example embodiment illustrated in FIG. 7, the cameras or other sensors 703 may be positioned onboard the vehicle. As a result, the vehicle teleoperation system 715 may not include or require additional cameras or other sensors, thereby simplifying at least the first portion 715-1 of the vehicle teleoperation system. The first portion 715-1 may receive the sensor data via sensor data interfaces 716 from the vehicle's onboard sensors 703, may process the sensor data using the processing islands 717 for video data, and may forward or transmit the processed sensor data to a teleoperator station via the connectivity island 718.

Moreover, by forming or developing the vehicle teleoperation system as two portions 715-1, 715-2, the cost and complexity of the single chip described with respect to the first example embodiment of FIG. 3 may be reduced, as two separate, relatively lower cost, and potentially simpler chips may be used for each of the two portions 715-1, 715-2. In addition, developing the sensor data interfaces 716, processing islands 717, and connectivity island 718 on a first portion 715-1, and developing the safety island 719 on a second portion 715-2 may reduce, mitigate, or uncouple potential issues or problems associated with one portion, while maintaining functions or operations associated with the other portion. However, various issues or problems may be increased or added by utilizing multiple portions or chips 715-1, 715-2, due to the additional components, parts, connections, or other aspects.

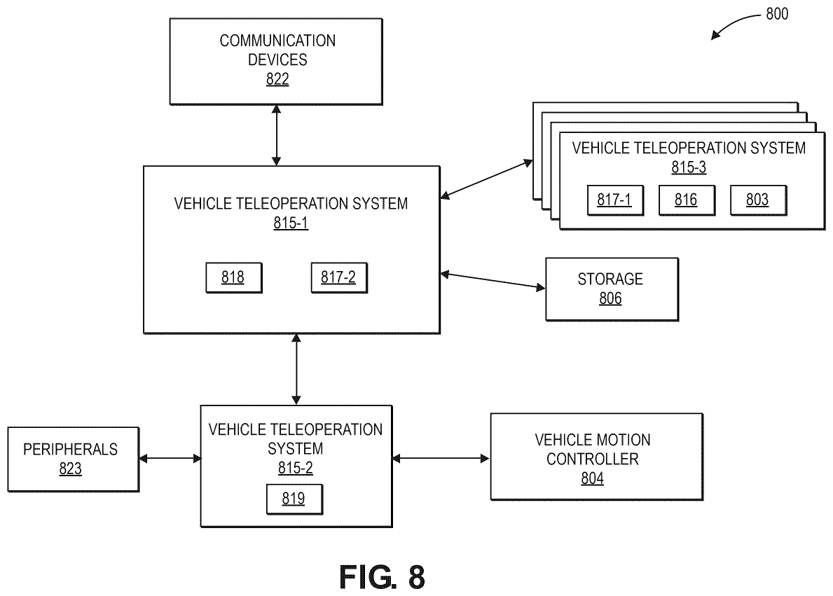

FIG. 8 is a schematic diagram 800 of a fourth example embodiment of a vehicle teleoperation system, in accordance with implementations of the present disclosure.

As shown in FIG. 8, the fourth example embodiment of a vehicle teleoperation system may comprise vehicle motion controller 804, storage 806, communication devices 822, and peripherals 823 that are substantially the same as those components described herein at least with respect to FIGS. 3, 6, and 7.

In contrast to the description of FIGS. 6 and 7, the vehicle may not include any onboard cameras, sensors, or sensor data processing units. Instead, the vehicle teleoperation system 815 may further comprise cameras or sensors 803, one or more sensor data interfaces 816, and processing islands 817-1 for video data. Furthermore, in contrast to the description of FIGS. 3, 6, and 7, the vehicle teleoperation system 815 may be formed or developed as three or more portions 815-1, 815-2, 815-3 upon three or more separate but physically, electrically, and/or functionally connected chips. For example, a first portion 815-1 of the vehicle teleoperation system may comprise a processing island 817-2 for connectivity data and a connectivity island 818, a second portion 815-2 of the vehicle teleoperation system may comprise a safety island 819, and one or more third portions 815-3 of the vehicle teleoperation system may comprise cameras or sensors 803, sensor data interfaces 816, and processing islands 817-1 for video data. The functions or operations of the processing islands 817-1, 817-2, connectivity island 818, and safety island 819 may be substantially the same as those components described herein at least with respect to FIGS. 3-7.

In the fourth example embodiment illustrated in FIG. 8, the cameras or other sensors 803, the video or other sensor data interfaces 816, and sensor data processing islands 817-1 may be formed as separate or modular portions 815-3 of the vehicle teleoperation system. Multiple modular portions 815-3 may be connected or coupled with other portions 815-1, 815-2 of the vehicle teleoperation system as needed or desired. As a result, the vehicle teleoperation system 815 may have a modular or scalable aspect by which any desired number, combination, or arrangement of cameras or sensors 803, sensor data interfaces 816, and sensor data processing islands 817-1 may be added or removed from the overall vehicle teleoperation system. The first portion 815-1 may receive the processed sensor data from the modular portions 815-3 of the vehicle teleoperation system, and may forward or transmit the processed sensor data to a teleoperator station via the processing island 817-2 and connectivity island 818.

Moreover, by forming or developing the vehicle teleoperation system as three or more portions 815-1, 815-2, 815-3, the cost and complexity of the single chip described with respect to the first example embodiment of FIG. 3, and/or the two chips described with respect to the second and third example embodiments of FIGS. 6 and 7, may be reduced, as three or more separate, relatively lower cost, and potentially simpler chips may be used for each of the portions 815-1, 815-2, 815-3. In addition, developing the processing island 817-2 and connectivity island 818 on a first portion 815-1, developing the safety island 819 on a second portion 815-2, and developing the sensors 803, interfaces 816, and sensor data processing islands 817-1 on third portions 815-3 may reduce, mitigate, or uncouple potential issues or problems associated with one portion, while maintaining functions or operations associated with other separate portions. However, various issues or problems may be increased or added by utilizing multiple portions or chips 815-1, 815-2, 815-3 due to the additional components, parts, connections, or other aspects.

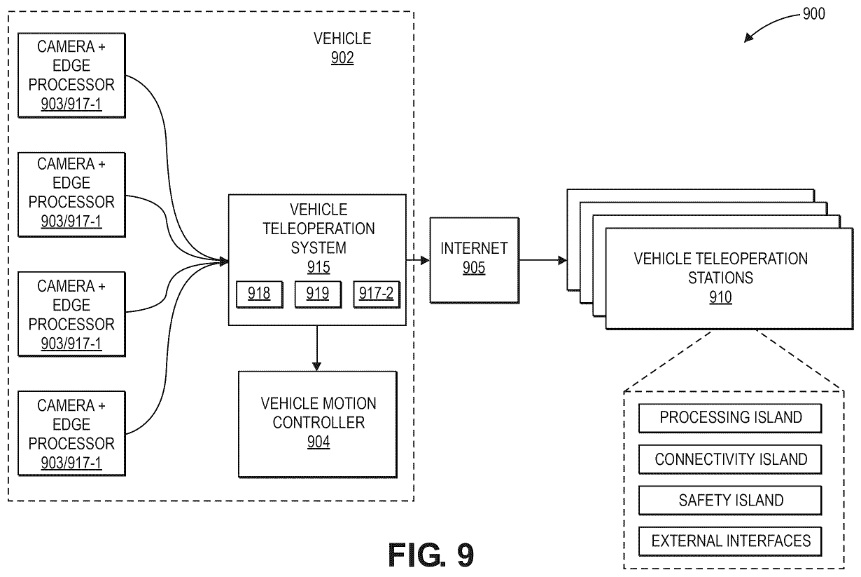

FIG. 9 is a schematic diagram 900 of a fifth example embodiment of a vehicle teleoperation system, in accordance with implementations of the present disclosure.

As shown in FIG. 9, the fifth example embodiment of a vehicle teleoperation system and remote driving system may comprise a vehicle 902, vehicle motion controller 904, network connection 905, vehicle teleoperator stations 910, and/or other components that are substantially the same as those components described herein at least with respect to FIGS. 1-3.

In contrast to the description of FIGS. 1-8, one or more cameras or sensors 903 and sensor data edge processing units 917-1 may be formed as individual, modular, distributed units, in which the cameras or sensors 903 may comprise edge processors 917-1 that can perform all the sensor data processing functions described herein. In this manner, the individual, distributed cameras or sensors 903 have associated edge processing units 917-1 may be added or removed from vehicles, and correspondingly coupled or decoupled from vehicle teleoperation systems, as needed or desired.

The vehicle teleoperation system 915 may comprise a processing island 917-2, connectivity island 918, and safety island 919 on one or more portions or chips, as further described herein. In addition, the functions or operations of the processing island 917-2, connectivity island 918, and safety island 919 may be substantially the same as those components described herein at least with respect to FIGS. 1-8.

In the fifth example embodiment illustrated in FIG. 9, the cameras or other sensors 903 and sensor data edge processing units 917-1 may be formed as separate, modular, or distributed units. Multiple modular cameras 903 and associated edge processors 917-1 may be connected or coupled with a vehicle and corresponding portions of the vehicle teleoperation system as needed or desired. As a result, the vehicle teleoperation system 915 and remote driving system as a whole may have a modular or distributed aspect by which any desired number, combination, or arrangement of cameras or sensors 903 having associated edge processors 917-1 may be added or removed from the overall remote driving system.

Although FIGS. 1-9 describe various example embodiments having particular combinations of components, features, and/or functions, various other example embodiments may include various additional modifications or changes to portions of the example vehicle teleoperation systems described herein. For example, the vehicle teleoperation systems may be formed or developed as various other numbers or arrangements of separate, modular, or distributed portions, various combinations of processors, chips, cores, microcontrollers, applications, or other hardware and/or software may be used to form the vehicle teleoperation systems, and/or various other changes or modifications may be made to the example vehicle teleoperation systems that are configured to enable remote operation of vehicles.

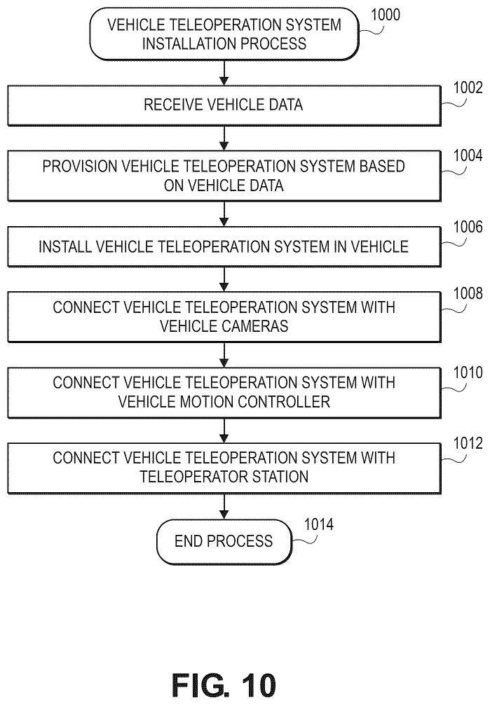

FIG. 10 is a flow diagram illustrating an example vehicle teleoperation system installation process 1000, in accordance with implementations of the present disclosure.

The process 1000 may begin by receiving vehicle data, as at 1002. For example, the vehicle data may comprise type, class, size, make, model, drivetrain, engine/motor, or various other characteristics or aspects associated with particular vehicles. Further, a control system or controller may instruct receiving the vehicle data.

The process 1000 may continue by provisioning a vehicle teleoperation system based on the vehicle data, as at 1004. For example, the vehicle teleoperation system may be adapted, modified, or otherwise provisioned to communicate with various systems onboard the vehicle, which may differ based on type, class, make, model, or various other vehicle data. Portions of the vehicle teleoperation system may be adapted to communicate with cameras, sensors, or sensor data processing units onboard a vehicle, other portions of the vehicle teleoperation system may be adapted to communicate with vehicle motion controller, peripherals, accessories, or other vehicle systems, and/or portions of the vehicle teleoperation system may be adapted to communicate with one or more teleoperator stations. Further, a control system or controller may instruct provisioning the vehicle teleoperation system based on the vehicle data.

The process 1000 may proceed by installing the vehicle teleoperation system in the vehicle, as at 1006. For example, the vehicle teleoperation system may be installed or assembled within the vehicle, e.g., substantially any portion of the vehicle. The installation location may be selected or determined in order to easily and reliably couple or connect with various systems of the vehicle, e.g., sensors, sensor data processing units, vehicle motion controller, peripherals, etc. In some examples, the vehicle teleoperation system may be installed within a trunk or boot, or under a hood of the vehicle. Further, a control system or controller may instruct installation of the vehicle teleoperation system in the vehicle.

The process 1000 may continue to connect the vehicle teleoperation system with vehicle cameras, as at 1008. For example, cameras, as well as audio sensors or other sensors, onboard the vehicle may be operatively coupled or connected with the vehicle teleoperation system. The cameras and sensors may be coupled via one or more sensor data interfaces associated with the vehicle teleoperation system, in order to provide or transmit sensor data to one or more processing islands for video and sensor data. Further, a control system or controller may instruct connection of the vehicle teleoperation system with vehicle cameras.

The process 1000 may proceed to connect the vehicle teleoperation system with a vehicle motion controller, as at 1010. For example, the vehicle motion controller may instruct remote driving operations or functions of the vehicle, e.g., throttle, braking, steering, and/or other functions. The vehicle teleoperation system may be operatively coupled or connected with the vehicle motion controller onboard the vehicle via one or more external interfaces, in order to provide or transmit commands or instructions from the processing islands and/or safety island to the vehicle motion controller. Further, a control system or controller may instruct connection of the vehicle teleoperation system with the vehicle motion controller.

The process 1000 may continue with connecting the vehicle teleoperation system with a teleoperator station, as at 1012. For example, the vehicle teleoperation system may comprise or couple with one or more communication devices, e.g., modems or other data transfer and communication devices. Using the communication devices, the vehicle teleoperation system may be configured to send and receive data to and from one or more teleoperator stations. For example, the vehicle teleoperation system may send or transmit sensor data to the teleoperator station for presentation to a teleoperator. In addition, the vehicle teleoperation system may receive user inputs, commands, or instructions from the teleoperator station for remote operation of the vehicle. Further, a control system or controller may instruct connection of the vehicle teleoperation system with a teleoperator station.

The process 1000 may then end, as at 1014.

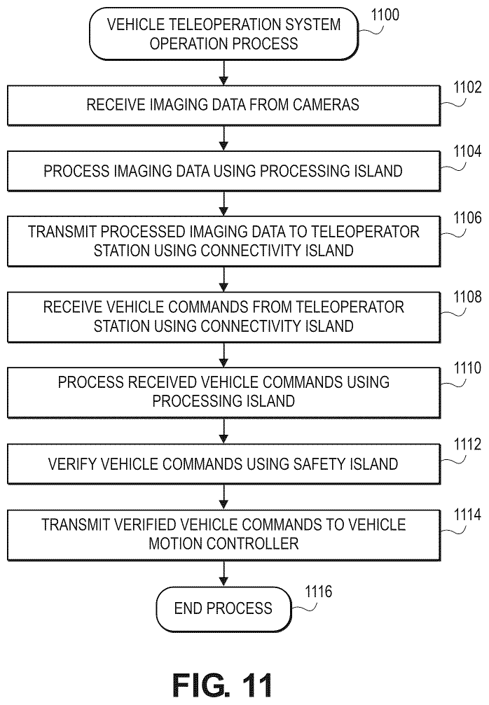

FIG. 11 is a flow diagram illustrating an example vehicle teleoperation system operation process 1100, in accordance with implementations of the present disclosure.

The process 1100 may begin by receiving imaging data from cameras, as at 1102. For example, one or more cameras, audio sensors, or other sensors associated with a vehicle may capture sensor data associated with an environment around the vehicle, as well as potentially sensor data associated with an interior, cabin, or passengers of the vehicle. The vehicle teleoperation system may receive the sensor data from the various sensors via sensor data interfaces, and the sensor data may be received by processing islands of the vehicle teleoperation system. Further, a control system or controller may instruct receiving imaging data, audio data, or other sensor data from cameras, audio sensors, and other sensors.

The process 1100 may continue by processing the imaging data using the processing island, as at 1104. For example, one or more processing islands for video data or other sensor data may comprise various applications, models, techniques, or algorithms to process the sensor data. Various imaging data processing applications, audio data processing applications, and/or other sensor data processing applications may be executed upon the received sensor data, in order to generate processed sensor data for presentation to a teleoperator at a teleoperator station. Generally, the processed sensor data may comprise imaging or video data, audio data, and/or other sensor data that may be relevant or important for safe and reliable remote operation of the vehicle. Further, a control system or controller may instruct processing the various sensor data using one or more processing islands.

The process 1100 may proceed by transmitting the processed imaging data to a teleoperator station using the connectivity island, as at 1106. For example, the processed imaging, audio, and/or other sensor data may be forwarded from the processing island to the connectivity island. The connectivity island may then transmit or send the processed sensor data to a teleoperator station via one or more communication devices and associated communication networks. Upon receipt, the teleoperator station may present or emit the processed sensor data to a teleoperator at the teleoperator station in order to enable remote driving operations. Further, a control system or controller may instruct transmitting the processed sensor data to a teleoperator station using the connectivity island.

The process 1100 may then continue to receive vehicle commands from the teleoperator station using the connectivity island, as at 1108. For example, based on the presented sensor data at the teleoperator station, the teleoperator may provide various user inputs, commands, or instructions related to remote operation of the vehicle. The user inputs may comprise commands related to throttle, braking, steering, lights, turn signals, and/or various other inputs to peripherals or accessories of the vehicle. The connectivity island may receive the user inputs, commands, or instructions via the communication devices from the teleoperator station, and may forward the user inputs to one or more processing islands for connectivity data. Further, a control system or controller may instruct receiving user inputs or commands from the teleoperator station using the connectivity island.

The process 1100 may proceed to process the received vehicle commands using the processing island, as at 1110. For example, one or more processing islands for connectivity data, user inputs, or vehicle commands may comprise various applications, models, techniques, or algorithms to process the user inputs data. Various remote driving applications, remote peripheral applications, and/or other data processing applications may be executed upon the received user inputs data, in order to generate appropriate or corresponding vehicle commands for transmission to a safety island. Generally, the user inputs data may be processed in order to generate appropriate vehicle commands based on the vehicle data, including type, class, make, model, etc. Further, a control system or controller may instruct processing the received vehicle commands using one or more processing islands.

The process 1100 may continue with verifying the vehicle commands using the safety island, as at 1112. For example, the safety island may comprise various applications, models, techniques, or algorithms to process the vehicle commands. As described herein, the safety island may process, analyze, provision, adapt, check, or verify the vehicle commands to ensure data integrity, completeness, accuracy, sequence, formatting, safety, and/or other aspects. Generally, the safety island may verify or validate that the received vehicle commands are safe, accurate, and appropriate for remote operation of the vehicle. Further, a control system or controller may instruct verifying the vehicle commands using the safety island.

The process 1100 may proceed with transmitting the verified vehicle commands to the vehicle motion controller, as at 1114. For example, the safety island may transmit the verified vehicle commands to the vehicle motion controller associated with the vehicle via one or more external interfaces. The verified vehicle commands may comprise commands related to throttle, braking, and steering. In addition, the verified vehicle commands may comprise commands related to various peripherals or accessories, e.g., lights, turn signals, hazard lights, windshield wipers, power doors or windows, HVAC systems, audio systems, and/or various other peripherals. Upon receipt of the verified vehicle commands, the vehicle motion controller may cause the vehicle to execute the remote driving commands. Further, a control system or controller may instruct transmitting the verified vehicle commands to the vehicle motion controller.

The process 1100 may then end, as at 1116.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 10 and 11, orders in which such methods or processes are presented are not intended to be construed as any limitation on the claimed inventions, and any number of the method or process steps or boxes described herein can be omitted, reordered, or combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A remote driving system, comprising:
a vehicle comprising a camera and a vehicle motion controller;
a vehicle teleoperation system installed within the vehicle and operatively coupled to the camera and the vehicle motion controller, the vehicle teleoperation system comprising:
a processing island operatively coupled to the camera;
a connectivity island operatively coupled to a network; and
a safety island operatively coupled to the vehicle motion controller;
wherein the vehicle teleoperation system comprises a single, integrated unit that is configured to be installed within the vehicle; and
a teleoperator station configured to communicate with the vehicle via the network, the teleoperator station being further configured to receive video data captured by the camera from the vehicle teleoperation system, and configured to transmit user commands received at the teleoperator station to the vehicle teleoperation system.

2. The remote driving system of claim 1, wherein the camera and the vehicle motion controller comprise existing equipment installed onboard the vehicle.

3. The remote driving system of claim 1, wherein the teleoperator station further comprises:
a presentation device configured to present the video data to a teleoperator at the teleoperator station;
a user interface configured to receive the user commands provided by the teleoperator at the teleoperator station;
a station connectivity island operatively coupled to the vehicle teleoperation system via the network, and configured to receive the video data and to transmit the user commands; and
a station processing island and a station safety island operatively coupled to the station connectivity island, and configured to process the video data and the user commands at the teleoperator station.

4. The remote driving system of claim 1, wherein the connectivity island is configured to communicate with the teleoperator station via the network using a plurality of communication devices; and
wherein respective ones of the plurality of communication devices receive and transmit data using different respective communication networks, operators, or providers.

5. The remote driving system of claim 1, wherein the vehicle motion controller is configured to control at least one of throttle, braking, steering, or at least one peripheral associated with the vehicle.

6. A system, comprising:
a processing island operatively coupled to at least one sensor associated with a vehicle;
a connectivity island operatively coupled to a teleoperator station via at least one network; and
a safety island operatively coupled to a vehicle motion controller associated with the vehicle;
wherein the processing island, the connectivity island, and the safety island comprise a single, integrated unit that is configured to be installed within the vehicle.

7. The system of claim 6, wherein the processing island comprises a first processing island that is configured to process sensor data from the at least one sensor for presentation by the teleoperator station;
wherein the first processing island is configured to at least one of select portions of the sensor data, filter the sensor data, compress the sensor data, perform adaptive bitrate encoding, perform region of interest encoding, or perform dynamic resolution rendering; and
wherein the at least one sensor comprises at least one of an imaging device, an audio sensor, or a time of flight sensor.

8. The system of claim 7, wherein the connectivity island is configured to receive the sensor data from the first processing island, and to transmit the sensor data to the teleoperator station using at least one communication device via the at least one network; and
wherein the connectivity island is configured to at least one of encrypt the sensor data, optimize data transmission for latency, or assess available bandwidth.

9. The system of claim 6, wherein the processing island comprises a second processing island that is configured to process user input data from the teleoperator station, and to transmit the user input data to the safety island; and
wherein the second processing island is configured to at least one of verify integrity of the user input data or verify latency of the user input data.

10. The system of claim 9, wherein the connectivity island is configured to receive the user input data from the teleoperator station using at least one communication device via the at least one network, and to transmit the user input data to the second processing island; and
wherein the connectivity island is configured to at least one of decrypt the user input data, optimize data reception for latency, or detect packet-loss of data.

11. The system of claim 9, wherein the safety island is configured to receive the user input data, and to transmit the user input data to the vehicle motion controller; and
wherein the safety island is configured to at least one of verify a latency, compensate detected latency, verify an integrity, verify timestamps, verify a sequence, verify an accuracy, apply an appropriate formatting based on at least one attribute of the vehicle, prevent erroneous inputs, apply limits to the user input data, or request a safety maneuver; and
wherein the safety maneuver comprises at least one of reducing a speed of the vehicle, stopping the vehicle, or performing a safety pull-over of the vehicle.

12. The system of claim 6, wherein one of:
the processing island and the at least one sensor are formed as part of the single, integrated unit;
the processing island is formed as part of the single, integrated unit, and the at least one sensor is integrated within the vehicle;
the processing island and the at least one sensor are integrated within the vehicle; or
the processing island and the at least one sensor are formed as a modular unit that is configured to be installed within the vehicle.

13. The system of claim 6, wherein one of:
the vehicle motion controller is formed as part of the single, integrated unit; or
the vehicle motion controller is integrated within the vehicle.

14. The system of claim 6, wherein the single, integrated unit comprises a single chip including the processing island, the connectivity island, and the safety island; or
wherein the single, integrated unit comprises multiple chips, and wherein the processing island and the connectivity island are formed as part of a first chip of the multiple chips, and the safety island is formed as part of a second chip of the multiple chips.

15. The system of claim 6, wherein the single, integrated unit comprises two portions in communication with each other, a first portion including the processing island and the connectivity island, and a second portion including the safety island.

16. A method, comprising:
receiving, by a processing island of a vehicle teleoperation system installed within a vehicle, sensor data from at least one sensor associated with the vehicle;
transmitting, by a connectivity island of the vehicle teleoperation system via a network, the sensor data to a teleoperator station for presentation to a teleoperator;
receiving, by the connectivity island via the network, user input data provided by the teleoperator of the teleoperator station;
processing, by at least one of the processing island or a safety island of the vehicle teleoperation system, the user input data to generate vehicle commands; and
transmitting, by the safety island, the vehicle commands to a vehicle motion controller associated with the vehicle;
wherein the processing island, the connectivity island, and the safety island comprise a single, integrated unit that is configured to be installed within the vehicle.

17. The method of claim 16, further comprising:
processing, by the processing island, the sensor data for presentation by at least one of selecting portions of the sensor data, filtering the sensor data, compressing the sensor data, performing adaptive bitrate encoding, performing region of interest encoding, or performing dynamic resolution rendering; and
forwarding, by the processing island, the sensor data to the connectivity island.

18. The method of claim 16, further comprising:
forwarding, by the connectivity island, the user input data to the processing island; and
wherein processing the user input data further comprises:
provisioning the user input data based on a type, class, make, model, or software associated with the vehicle to generate the vehicle commands.

19. The method of claim 16, further comprising:
forwarding, by the processing island, the user input data to the safety island; and
wherein processing the user input data further comprises:
verifying, by the safety island, at least one of latency, integrity, timestamps, sequence, accuracy, safety, or formatting associated with the user input data to generate the vehicle commands.

20. The method of claim 16, wherein the teleoperator station further comprises at least one of:
a station processing island configured to process the sensor data from the at least one sensor associated with the vehicle;
a station connectivity island configured to receive the sensor data, and to transmit the user input data provided by the teleoperator of the teleoperator station; or
a station safety island configured to process the user input data to generate vehicle commands to be transmitted to the vehicle motion controller associated with the vehicle.
